(19) United States
(12) Patent Application Publication
(10) Pub. No.: US 2015/0235194 A1
(43) Pub. Date: Aug. 20, 2015

(54) METHOD, SYSTEM AND PROGRAM PRODUCT FOR SOCIAL ANALYTICS DURING PURCHASING

(71) Applicant: Mohammad Rashid, Maple Grove, MN (US)

(72) Inventor: Mohammad Rashid, Maple Grove, MN (US)

(21) Appl. No.: 14/467,168

(22) Filed: Aug. 25, 2014

Related U.S. Application Data
(63) Continuation of application No. 14/182,014, filed on Feb. 17, 2014, now abandoned.

(51) Int. Cl. G06Q 20/20; G06Q 50/00

(52) U.S. Cl. CPC G06Q 20/202; G06Q 50/01

(57) ABSTRACT

A method, system and program product comprises transmitting at least an identifying information for an item to a server system. The item is chosen by a customer for purchase. The server system is configured for communicating with at least a social media platform to communicate at least a part of the identifying information wherein the social media platform returns to the server system at least one social media content related to the item. At least the one social media content is received from the server system. A filtering process is applied to the received at least one social media content. The filtering process determines a disposition of the received at least one social media content for displaying to the customer.

### RELATED CO-PENDING U.S. PATENT APPLICATIONS

The following related U.S. patent application, submitted by at least one of the present Applicant(s)/Inventor(s) are recently co-pending: U.S. Utility patent application Ser. No. 14/182,014 entitled “Method of Delivery, Display, Print and email of Social Media Content Using a Point of Sales POS Terminal Software and a Receipt Printer”, submitted to the United States Patent and Trademark Office (USPTO) on 17 Feb. 2014.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to computer software. More particularly, the invention relates to point of sale software.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In many instances, people may be benefited by a system which may effectively digitize user activities to create a virtual network through which many people may communicate and receive personalized information based on advanced social analytics.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art shows a secure element physically coupled to a mobile communication device to allow for transactions with remote terminals such as point-of-sale and point-of-entry terminals. By way of educational background, another aspect of the prior art generally useful to be aware of teaches of systems and methods for the capture of retail transaction data from a print data stream after it has been processed by a POS system. Another such aspect of the prior art discloses of a system whereby customers may register a social networking identifier with a retail loyalty program. Yet another such aspect of the prior art discloses a system and method configured to provide enhanced services based on check-in information observed in a payment processing system. Still another such aspect of the prior art discloses of aggregating product saving into a quick response (QR) code and providing a targeted offer via a financial transaction receipt. However, these solutions may not provide a system which may utilize advanced social analytics to assist in social interaction between a variety of people as a result of various actions, including, without limitation, purchasing items at a store. A solution which did so would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1D illustrations of exemplary POS software interfaces, in which FIG. 1A is a standard POS interface, FIG. 1B is a POS interface with social media functionality and having a single social media icon, FIG. 1C is a POS interface with social functionality and having multiple social media icons, and FIG. 1D is a POS interface with an external monitor having social media functionality, in accordance with an embodiment of the present invention;

FIG. 2 is an illustration of an exemplary system for providing personalized data based on user actions, in accordance with an embodiment of the present invention;

FIG. 3 is an illustration of an exemplary system for determining personalized data based on user information, in accordance with an embodiment of the present invention;

FIG. 4 is an illustration of an exemplary method for providing unique data in response to user actions, in accordance with an embodiment of the present invention;

FIG. 5 is an illustration of an exemplary interface and/or document having multiple samples of content 125, in accordance with an embodiment of the present invention;

FIG. 6 is an illustration of an exemplary retail receipt with one or more samples of content 125, in accordance with an embodiment of the present invention;

FIG. 7 is an illustration of an exemplary digital copy of a document having one or more samples of content 125, in accordance with an embodiment of the present invention;

FIG. 8 is a block diagram depicting an exemplary client/server system which may be used by an exemplary web-enabled/networked embodiment of the present invention; and

FIG. 9 illustrates a block diagram depicting a conventional client/server communication system.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, Firefox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

Some embodiments of the present invention may provide means and/or methods for providing uniquely generated content to users based on user actions. In a non-limiting example, a user action may be making purchases and uniquely generated content may be information associated with user's point of sale (POS) receipt.

In some embodiments, a POS terminal may print itemized invoices of customer purchases which may include, without limitation, amount due for each item, applicable taxes, and total amount due. In some of these embodiments, POS terminal may also print content which may be uniquely tailored to individual users. In one embodiment, content may relate to social media. In many instances, social media may refer to interaction among people in which people create, share, and/or exchange information and/or ideas in virtual communities and/or networks. In some instances, social media may be one or more internet-based application that may build on ideological and/or technological foundations of, without limitation, Web 2.0, and may allow creation and/or exchange of user-generated content. Furthermore, in some instances, social media may depend on mobile and/or web-based technologies to create highly interactive platforms through which individuals and/or communities may share, create, discuss, and/or modify user-generated content. In many instances, social media technologies may take on many different forms including, without limitation, magazines, internet forums, weblogs, social blogs, microblogging, wikis, social networks, podcasts, photographs, pictures, video, rating and social bookmarking. In some instances, technologies may include, without limitation, blogging, picture-sharing, vlogs, wall-posting, music-sharing, crowdsourcing, voice-over IP, etc. Often, social network aggregation may integrate multiple platforms. For simplicity, social media platforms may be considered to belong to one or more categories, including, without limitation: collaborative projects (Wikipedia, etc.); blogs/microblogs (Digg, Leakernet, etc.; content communities (YouTube, DailyMotion, etc.); social networking (Facebook, etc.); virtual-game worlds (World of Warcraft, etc.); and virtual social worlds (Second Life, etc.). In some instances, some social media platforms may be represented as combinations of multiple types. In a non-limiting example, Twitter may be considered a combination of a broadcasting service and a social network, and may as a result be considered a “social broadcasting technology”.

Many embodiments of the present invention may provide means and/or methods for linking various items to social media content. In some embodiments, such items may include, without limitation, universal product codes (UPCs), quick response (QR) codes, uniform resource locators (URLs), etc. In one embodiment, items may deliver information to social media platforms. In other embodiments, social media platforms may deliver information to various electronic devices. In some embodiments, suitable electronic device may include, without limitation, smartphones, laptop computers, tablets, POS devices, etc. In a non-limiting example, a cash register at a store may be suitable for sending consumer purchase data to a social media platform. In the present non-limiting example, the cash register may also receive data from any external source which may provide unique advertising or a unique QR code that may relate to a consumer's determined tastes based on purchases.

Some embodiments may be suitable for supporting idea management by engaging a community to share, capture, and/or vote on ideas to create and/or improve products, service pricing, packaging, distribution channels and other issues. In a non-limiting example, an airline may use Facebook to gather ideas for a limited-time summer route from Oslo. In the present non-limiting example, the airline may receive most votes for a route from Oslo to Alanya, Turkey, and may as a result open such a route. In some embodiments, system may use POS data for social engagement through gathering information about what consumers may frequently purchase in given areas. In the present non-limiting example, by printing media content on the ticket a customer may be engaged to participate in the voting based on customer purchase history in Alanya, Turkey and Oslo. In another non-limiting example, customer may use a mobile app to scan a barcode and provide feedback. In another non-limiting example, an airline may also print new route information such as, but not limited to, upcoming flight schedules, etc. and a customer may provide feedback regarding flying time. In another non-limiting example, based on a customer profile an airline may also print, but not limited to, social activity information, and current buzz that may interest the customer. In another non-limiting example, an airline may engage or be affiliated with a rental car company or other outlet to deliver social media message which may help customers. In the present non-limiting example, during renting a car, a customer may be advised of poor road condition/construction and delays based on real time social media feedback and the customer may choose to travel via air.

One or more embodiments may be suitable for performing market research for new products and/or test launches through collecting feedback before and/or after a launch from various communities. In a non-limiting example, a hotel chain may create communities to help in planning new locations for hotels. Asking real potential customers based on their POS profile and receiving their feedback may help greatly when planning for a hotel. In the present non-limiting example, a hotel company may connect with an airline and rental car company and print on their receipt asking to gather customer preference before hotel is build. They may capture information about what a customer would prefer when they stay such as, but not limited to, a larger pool, gym, mattress type, etc. With POS data the hotel may target the right people for the right question. Someone who might not care about a gym may appreciate a question about gym size or what machine he would like to use. Goal is to target the right people with right question without overwhelming them. Currently marketing campaign cannot solve this. With POS and social media response, hotel management may also consider customers prior experience and may try to accommodate.

Some embodiments may be suitable for social media monitoring and/or response tools to promote, develop, strengthen, and/or defend a product or company brand on social sites. In a non-limiting example, a company may highlight its products on Pinterest, and may have contests and invitations to share themed pin boards to invite customer engagement in unconventional categories. In some of these embodiments, messages may be printed on POS receipts based on customer demography. In a non-limiting example, a key factor of a user's demography may be user's choice of buying a certain company's products.

One or more embodiments may be suitable for providing advanced social analytics which may be used to: identify influencers, prospects and trends; profile customers; evaluate campaigns; and classify social content by subject/topic, sentiment, and intent. In a non-limiting example, a company may manage a software application which may use social analytics to integrate company loyalty/CRM (customer relationship management) data with Facebook data to create personalized content, offers, and perks to targeted customer segments. In the present non-limiting example, company may target individuals based on shopping habits.

One or more embodiments may be suitable for assisting social campaigns by offering capabilities for tracking, monitoring, and/or utilizing community and strength of relationships to target different segments of a community (e.g. influencers) in a campaign. In some of these embodiments, system may enable marketers to make real-time adjustments to campaigns, rather than making changes after the fact. In a non-limiting example, a resort company may provide destination-based stay and travel data and may provide visitors with multiple social destinations to upload pictures and video of trips. In the present non-limiting example, company may use Facebook and Twitter for real-time messages about events at resorts such as latest offers and packages to various events. Further, in the present non-limiting example, company may publish content for event awareness of upcoming or ongoing events based on consumer purchases. People may reserve or pay for hotel way in advance, and based on that and next purchases, event and social messages may be printed on POS receipt. As a non-limiting example, a person bought a hotel ticket for Florida and based on the person's purchase and profile next time the person buys a fishing rod from a target in Minneapolis, a social media content may be printed regarding a fishing event in Florida which the person may be interested in.

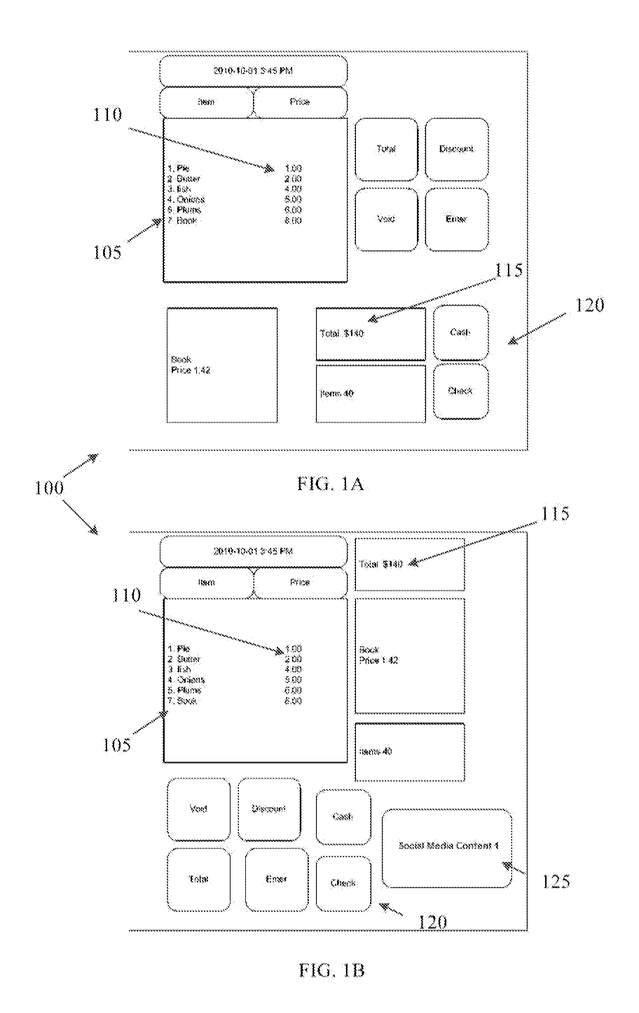

FIG. 1A through 1D are illustrations of an exemplary POS software interface, in which FIG. 1A is a standard POS interface, FIG. 1B is a POS interface with social media functionality and having a single social media icon, FIG. 1C is a POS interface with social functionality and having multiple social media icons, and FIG. 1D is a POS interface with an external monitor having social media functionality, in accordance with an embodiment of the present invention. In many instances, a traditional POS system may provide functionality to a user (e.g. a cashier) to complete a sale transaction. In the present embodiment, a user may enter items 105 into interface. In a non-limiting example, a user may enter an item 105 by keying an item number or scanning a bar code which may translate to a UPC. In the present embodiments, items 105 may be associated with various information, including, without limitation, price 110. In a non-limiting example, interface may retrieve price 110 from a database. In the present embodiment, interface may determine a total 115. In a non-limiting example, a total 115 may incorporate total sales and applicable taxes. In the present embodiment, interface may show possible payment methods 120 and upon completion of payment system may send data to a printer to print a receipt. In some embodiments, system may send data to various external receivers, including, without limitation, social media platforms. In the present embodiment, content 125 from external sources may be displayed on interface. In a non-limiting example, a system may send item 105 information, either specific item 105 identification tags or UPCs, to an external social media platform, and social media platform may perform a search for relevant content 125 which may be applicable to item 105 information. In the present non-limiting example, social media platform may then send content 125 to be displayed at POS terminal or other device. In other embodiments, content 125 may be random. In a non-limiting example, if a social media platform is unable to find any related content 125, platform may send random content 125. In some of these embodiments, random content 125 may be selected from categories as determined by source of data request. In a non-limiting example, a POS terminal at a grocery store may receive random data from a category of suitable data for use by the grocery store. In some embodiments, external system may continuously and/or repeatedly send new data to system. In some of these embodiments, data may be prioritized to determine which data may be displayed. In a non-limiting example, a POS terminal system may have code/rules/filter logic to prioritize what to display in the terminal. One or more messages may be displayed in sequence. In some embodiments, rule/filter/logic in POS terminal may print one or more of the messages. In some embodiments, an external terminal may display message while the cashier is scanning items and the customer is watching. In many embodiments, content 125 and/or other components of graphical user interface may be located at any portion of interface. In other embodiments, content 125 may not be displayed, but may be sent digitally. In a non-limiting example, a user may print or e-mail content125 without viewing content 125. In the present embodiment, interface may display multiple samples of content 125, as illustrated in FIG. 1C. In some embodiments, users may select individual samples of content 125. In a non-limiting example, a user may select an individual sample, and selected sample may be printed on receipt or included in e-mailed copy of receipt. In some of these embodiments, if users do not select an individual sample, system may select a random sample from available options. In the present embodiment, system may display content 125 in an external display 130, as illustrated in FIG. 1D. In a non-limiting example, a touch screen may be an external display 130 for a POS terminal. In some embodiments, external display 130 may display multiple samples of content 125. In one embodiment, users may interact with external display 130 to view external websites or other software to view more information about displayed content 125.

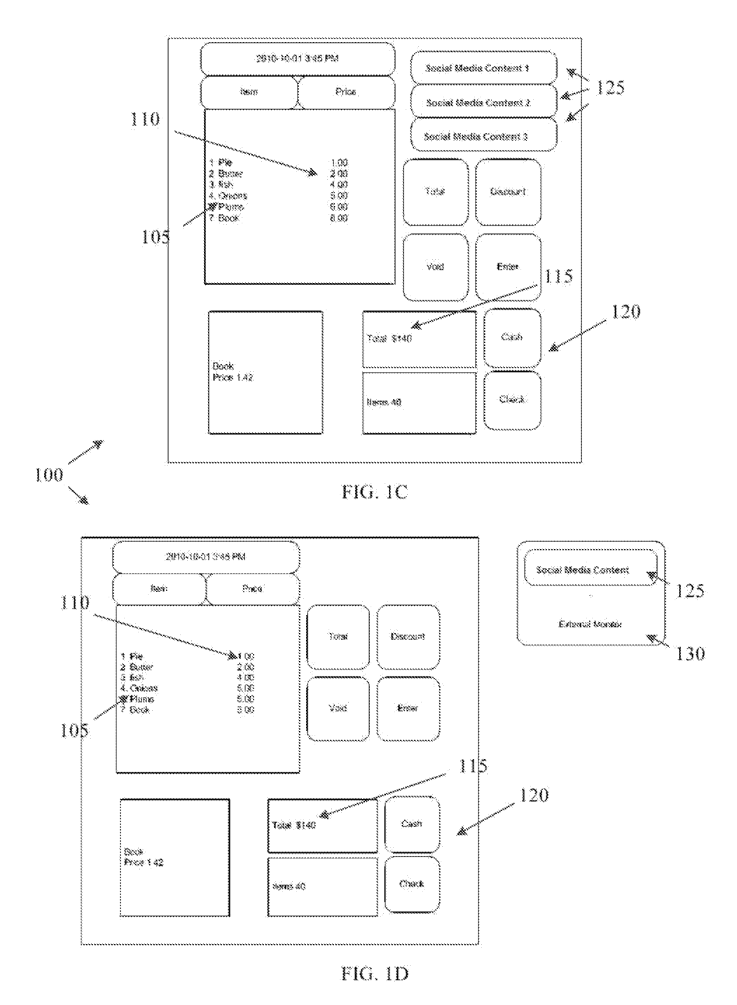

FIG. 2 is an illustration of an exemplary system for providing personalized data based on user actions, in accordance with an embodiment of the present invention. In the present embodiment, a user 205 may initiate a transaction. In a non-limiting example, a user 205 may be a cashier ringing up a commerce transaction. In the present embodiment, content 125 may be displayed at a POS terminal 210 or external display 215. Further, in the present embodiment, content 125 may be printed independently or as part of a document (e.g. a receipt) from a printer 220 and/or may be sent as a digital copy 225. In a non-limiting example, a user may receive an e-mail with a digital copy 225 of content 125 and/or a document with content 125. In the present embodiment, terminal 210 may communicate via an internet and/or intranet connection with various software and/or hardware suitable for servicing content 125 data, including, without limitation, a content service interface 230, a database 235, and a content generating interface 240. In some embodiments, content service interface 230 may process information from terminal 210 and/or search criteria. In one embodiment, database 235 may be suitable for storing and/or retrieving relevant content 125 based on any search criteria. In some embodiments, content generating interface 240 may be suitable for generating content 125 based on a variety of received data and/or internal data. In one embodiment, terminal 210 may send a print notification to content servicing interface 230 upon successful printing or e-mailing of a document. In some embodiments, billing and/or account processing may be performed by terminal 210 and/or one or more of external interface components, including, without limitation, content servicing interface 230 or content generating interface 240.

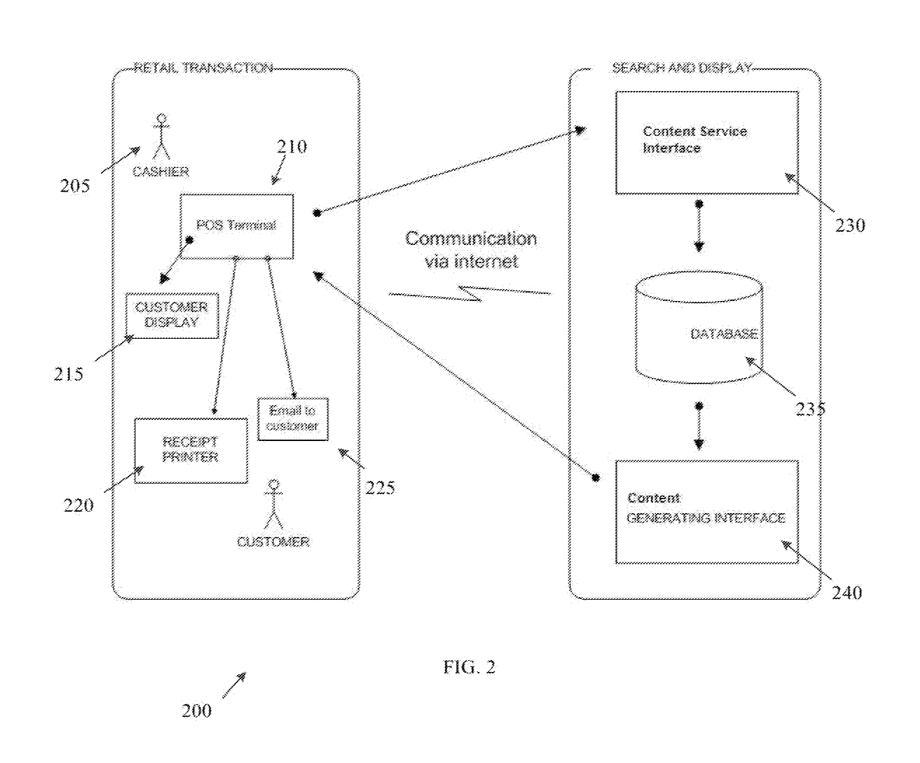

FIG. 3 is an illustration of an exemplary system for determining personalized data based on user information, in accordance with an embodiment of the present invention. In the present embodiment, a cashier 302 and a customer 305 may interact with a computer system 301 in various ways, including, without limitation, using a scanning module 310 to scan items, accessing a software application 330, and/or using a display screen 335.

In the present embodiment, scanning module 310 may include, without limitation, a barcode reader, also called a price scanner or point-of-sale (POS) scanner. In some embodiments, the barcode reader may be a hand-held or stationary input device used to capture and read information contained in a bar code. The barcode reader may comprise, but not limited to, a scanner, a decoder (either built-in or external), and a cable used to connect the reader with a computer. Typically a barcode reader captures and translates the barcode into numbers and/or letters to be sent to a computer. In some embodiments, barcode scanners may be connected to a computer through, but not limited to, a serial port, keyboard port, an interface device called a wedge or wireless. A data transmission module 315 may provide a data structure to communicate with a processing layer, messaging the data that comes back and feed it to an application module 330. A QR code generator 320 may convert any information into a QR code that may be printed via a printing module 339. QR code generator 320 may use an algorithm to convert for example, but not limited to, a website address, login information or login ID to portal, or a unique ID code into QR code which customer 305 may scan with a mobile app and may be granted access or routed to specific web address. The application module 330 is where the main POS application resides. Application module 330 may interface with all other modules. The display module 335 may convert the messages into a pictorial format or text and display in the appropriate places in the POS application. A payment processing module 337 may processes a payment. Payment information may be sent to a processing system 350 and may receive information to be processed by application module 330. A printing module 339 may handle printing of a receipt along with, but not limited to, a QR code, bar code etc.

In the present embodiment, a rule processing module 352 may support, but not limited to, rules, facts, priority (score), mutual exclusion, preconditions, and other functions. In some embodiments, a rule engine software may be provided as a component of a business rule management system which, among other functions, may provide the ability to, without limitation, register, define, classify, and manage all the rules, and verify consistency of rules definitions. In non-limiting examples of rules, a customer opted out so do not print any social media content and maximum media content collected for a period cannot exceed 300. In some embodiments, rule processing module 352 may define the relationships between different rules, and relate some of these rules to applications that are affected or needed to enforce one or more of the rules. In the present embodiment, data analytics module 354 may include data mining as an analytic process designed to explore data in search for consistent patterns and/or systematic relationships between variables, and then to validate the findings by applying the detected patterns to new subsets of data. In some embodiments, the process of data mining comprises three stages: (1) the initial exploration, (2) model building or pattern identification with validation/verification, and it is concluded with (3) deployment (i.e., the application of the model to new data in order to generate predictions).

In the present embodiment, customer 305 may access a customer portal 360. In many embodiments, customer portal may comprise an application executing on a mobile computing device. In other embodiments, customer portal 360 may be accessed through any computing device having an internet connection. A view sales data module enables customer 305 to view their existing purchase data if they are ‘opted in’—in the customer portal. An update social media module 364 enables customer 305 to send feedback to a social media portal and share their retail experience. A provide feedback module 366 enables customer 305 to provide feedback.

In the present embodiment, database 340 may have multiple categories of data, including, without limitation, user profile 342, user transaction history 344, user social media 346, and user demographic information 348, from which database 340 may determine relevant personalized content 125. In some embodiments, users may be provided unique messages based on analysis by an analytics server and/or rule engine. In a non-limiting example, a customer may be sent a message reading “Based on your purchase pattern, you forgot to buy eggs,” or “Your friend ‘so and so’ had very negative feedback for ‘this’ product; consider returning?”

In the present embodiment, data aggregator 370 includes a social media data aggregator 372 and 3^{rd} party data provider 376 where content is collected and stored from social media portals and other 3rd party aggregators. A social media API 374 provides direct access to social media portals.

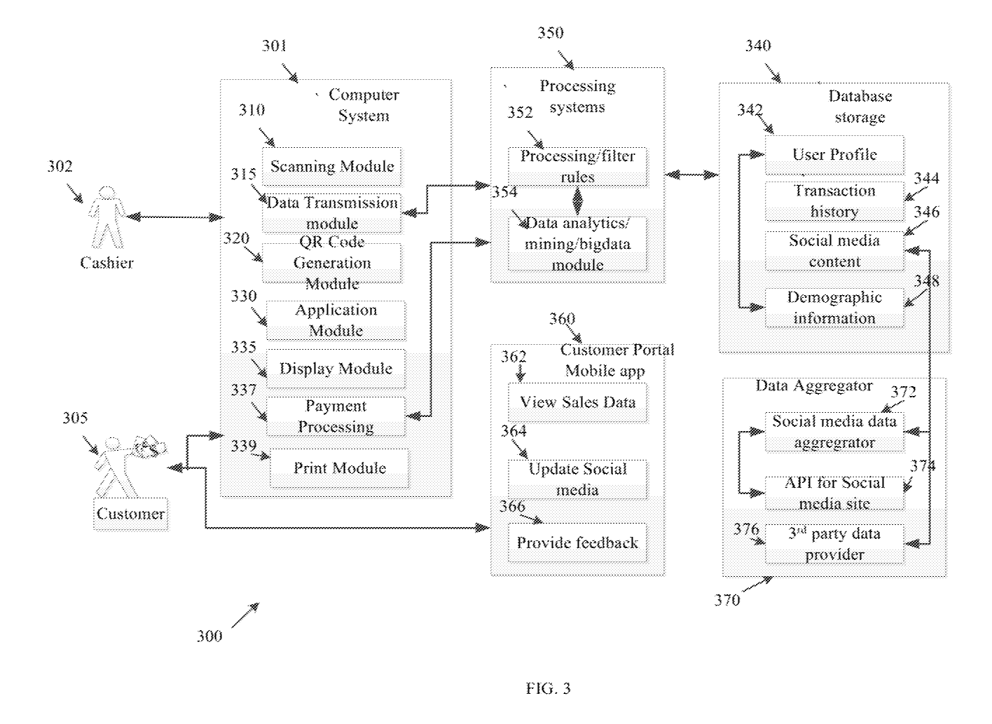

FIG. 4 is an illustration of an exemplary method for providing unique data in response to user actions, in accordance with an embodiment of the present invention. At the beginning of a transaction a customer may provide customer identification such as, but not limited to, by using a frequent shopper card or scanning a credit card. In a non-limiting example, terminal 210 may ask the customer to scan a credit card or a frequent shopper card or scanning a Mobile phone QR code or barcode. In the present embodiment, terminal 210 may send data to a content servicing interface 230 in a step 405. In some embodiments, data may be transferred by means of a network interface and may be in any suitable form, including, without limitation, item code, UPC, etc. In a non-limiting example, terminal 210 may send data regarding user purchases or other user actions. In another non-limiting example, terminal 210 may send a null or 0 to request random data. In the present embodiment, content servicing interface 230 may determine if received data contains a content-identifying attribute, or identifier, in a step 410. Content identifying attribute may be, without limitation, UPC code/zip code/store location where based on these data a specific message may be brought back from server. If no data is sent or a UPC is not used a random or generic message may be brought back. In a non-limiting example, any non-zero data may be a suitable identifier. In the present embodiment, if content servicing interface 230 does not receive a suitable identifier, interface 230 may return random content 125 in a step 415. Further, in the present embodiment, content servicing interface 230 may determine if the customer has been identified in a step 417. If the customer has not been identified, interface 230 may instruct database 235 to find any relevant content 125 based on no customer profiling in a step 419. Further, in the present embodiment, if interface 230 receives a suitable identifier and the customer has been identified, interface 230 may instruct database 235 to find any relevant content 125 based on customer profiling in a step 420. In some embodiments, if database may be unable to locate relevant content 125, database may return random content 125. In one embodiment, content 125 may be selected based on a variety of factors, including, without limitation, category, transaction type, location, business type requesting content 125, etc. In the present embodiment, content generating interface 240 may send content 125 to terminal in a step 425. In some embodiments, multiple samples of content 125 may be received and/or sent. In the present embodiment, terminal 210 may determine whether to display received content 125 in a step 430. In some embodiments, local filtering may be applied to determine whether to display the received content. In a non-limiting example, mature or adult rated content may not be displayed in a children's store. If a returned content is not to be displayed, interface 230 may instruct database 235 to find a next relevant content 125 in a step 440. In some embodiments, system may either display content 125 or send content 125 to another location, including, without limitation, a printer, a user's e-mail address, etc. In some embodiments, system may cache content for printing after sale is completed. In other embodiments, system may perform all possible functions. In the present embodiment, system may display content 125 in a step 435. In many embodiments, user may select one or multiple samples to display and/or send. In one embodiment, if user does not select any samples, system may print and/or send pre-determined number of samples in a random order. In some embodiments, system may flag to disable any content 125 for specific transactions or all transactions. In the present embodiment, content servicing interface 230 may determine if the sale is to be completed in a step 445. If more items are to be scanned the process returns to step 405. If the all items have been scanned the sale is completed in a step 450. In the present embodiment, content servicing interface 230 may determine if a customer profile has been identified in a step 460. If a customer profile has been identified during step 450 a customer profile based content, from cache or requested from database 235, is printed in a step 470. If a customer profile has not been identified content, from cache or requested from database 235, is printed in a step 465.

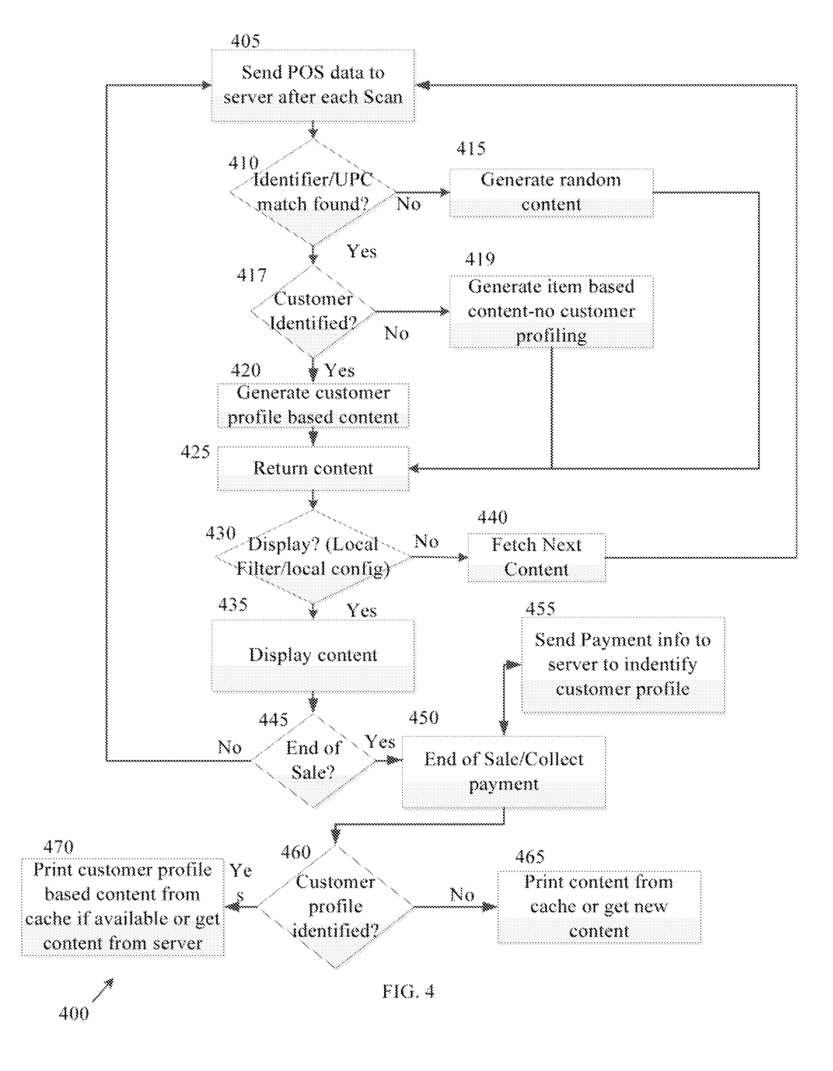

FIG. 5 is an illustration of an exemplary interface and/or document having multiple samples of content 125, in accordance with an embodiment of the present invention. In the present embodiment, content 505 may be in any suitable form, including, without limitation, QR code. In some embodiments, multiple samples of content 405 may appear on an interface and/or document.

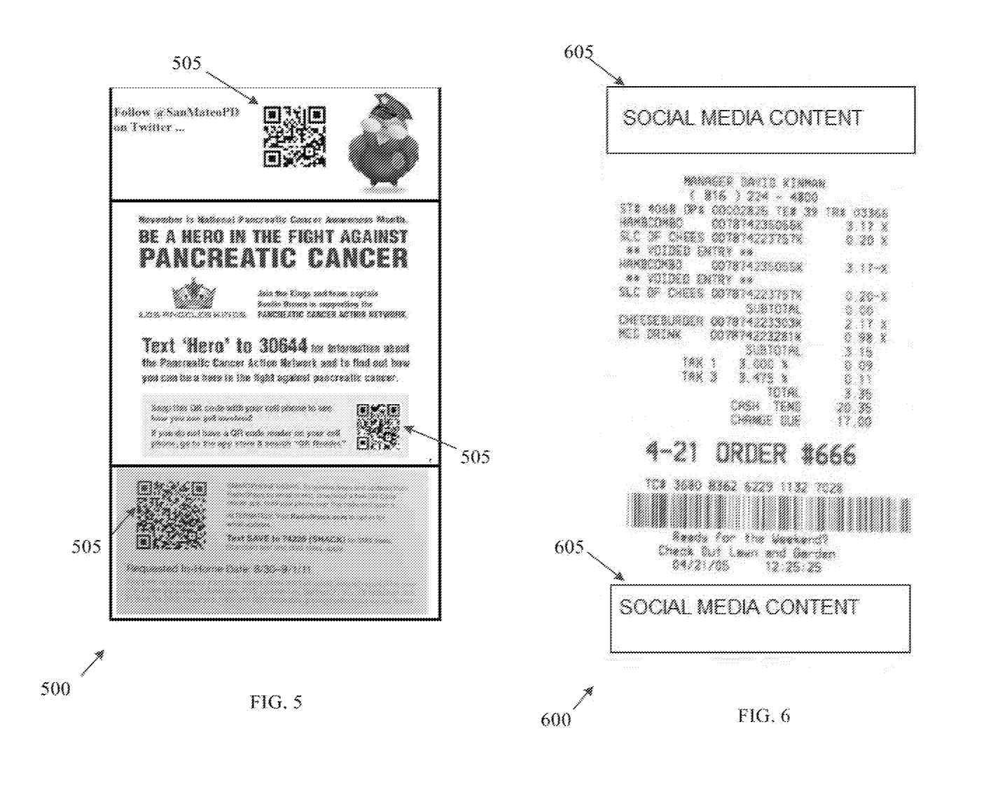

FIG. 6 is an illustration of an exemplary retail receipt with one or more samples of content 125, in accordance with an embodiment of the present invention. In the present embodiment, content 605 may be situated at a top and bottom area. In other embodiments, content 605 may be situated at any portion of a virtual and/or physical document. In a non-limiting example, content 605 may be a background image of a physical or virtual document. In another non-limiting example, content 605 may be situated on a back, or reverse, side of a physical or virtual document.

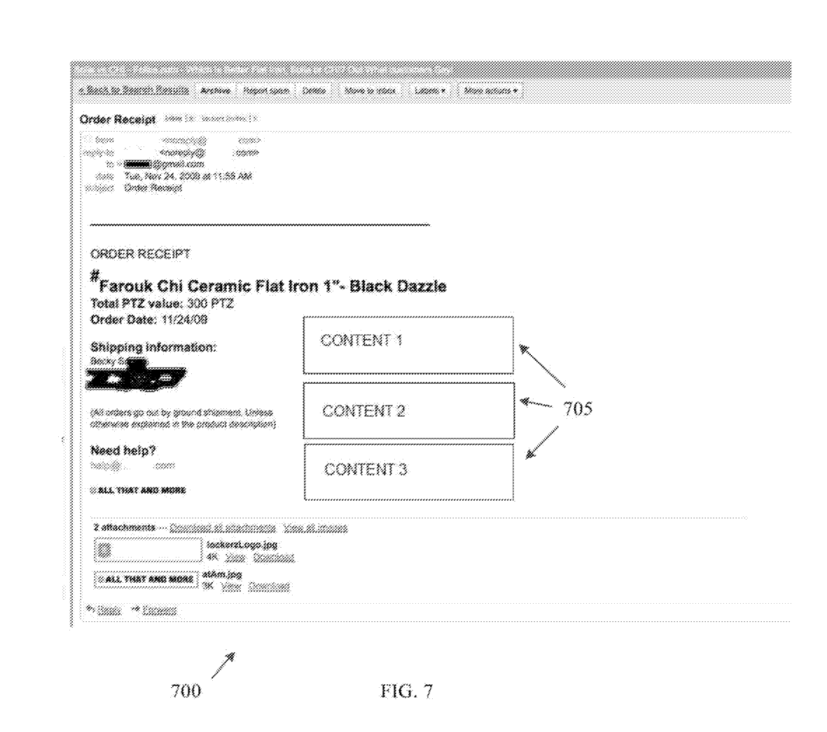

FIG. 7 is an illustration of an exemplary digital copy of a document having one or more samples of content 125, in accordance with an embodiment of the present invention. In the present embodiment, document may have multiple samples of content 705. In some embodiments, digital documents may be in any format, including, without limitation, PDF or standard e-mail format.

Some embodiments may be suitable for integrating interactive content 125 with digital and/or physical documents. In a non-limiting example, custom social media content 125 may be printed on a retail receipt. In some of these embodiments, content 125 may be based on rules or sets of rules and may depend on various personalized factors, including, without limitation, personality, profile, items purchased, etc. In at least one embodiment, users may use content 125 to interact and/or provide feedback. In a non-limiting example, a customer may “like” or “dislike” items, post comments, etc. In another non-limiting example, a customer may share information publicly and/or share a selected product in customer's own network via a social media platform.

Many embodiments may be suitable for allowing users to access social media platforms to share experiences with private or public groups. In some of these embodiments, users may access platforms using any suitable device, including, without limitation, smartphone, tablet, etc. In some embodiments, users may opt out by providing personal user information.

Some embodiments may be suitable for use in retail settings. In a non-limiting example, a retailer may implement system to match prices before finalizing transactions so as to avoid unnecessary returns. In another non-limiting example, a retailer may block purchases based on severely negative feedback by customers. In yet another non-limiting example, retailers may use system for product recall to avoid risk to public health.

In some alternative embodiments, software may be suitable for creating virtual representations of items which users may encounter and/or actions which users may perform. In a non-limiting example, a user shopping at a furniture store may scan a barcode for a couch into user's smartphone. In the present non-limiting example, user may have a software application which may be suitable for creating a virtual representation of the couch and placing it in a virtual living space along with other items user may have “collected” by similarly inputting them into user's account. In some of these alternative embodiments, users may share their virtual living spaces with other users. Some of these embodiments may provide users an opportunity to preview a living space prior to making purchases and/or prior to putting effort into arranging furniture in a variety of ways.

In other alternative embodiments, users may access software to view user history of items purchased in a given period of time, e.g. a year. In a non-limiting example, a user may use software to see how much of each kind of food a user purchased in a given year to evaluate user's eating habits. In some of these alternative embodiments, users may compare user history to other users' histories. In one of these embodiments, other users' identities may be anonymous.

In other alternative embodiments, a POS terminal may house the database itself. In other alternative embodiments, a POS terminal may also run the process to get data from social network sites. In other alternative embodiments, another implementation may be a batch mode where data may be downloaded daily and stored in local network. In other alternative embodiments, someone may pre-print the social media message before or after the sales as a separate transaction in the POS receipt. In other alternative embodiments, someone may preprint social content in a POS receipt and hand it over to customer after the sales receipt prints. In other alternative embodiments, someone may send the social media message via other means instead of making it part of POS receipt such as, but not limited to, SMS or email links. In other alternative embodiments, for identifying or profiling a customer someone may input an identifier such as, but not limited to, an email address, Facebook ID or other identifying ID. In other alternative embodiments, a customer may be preregistered and provided with an unique customer ID.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

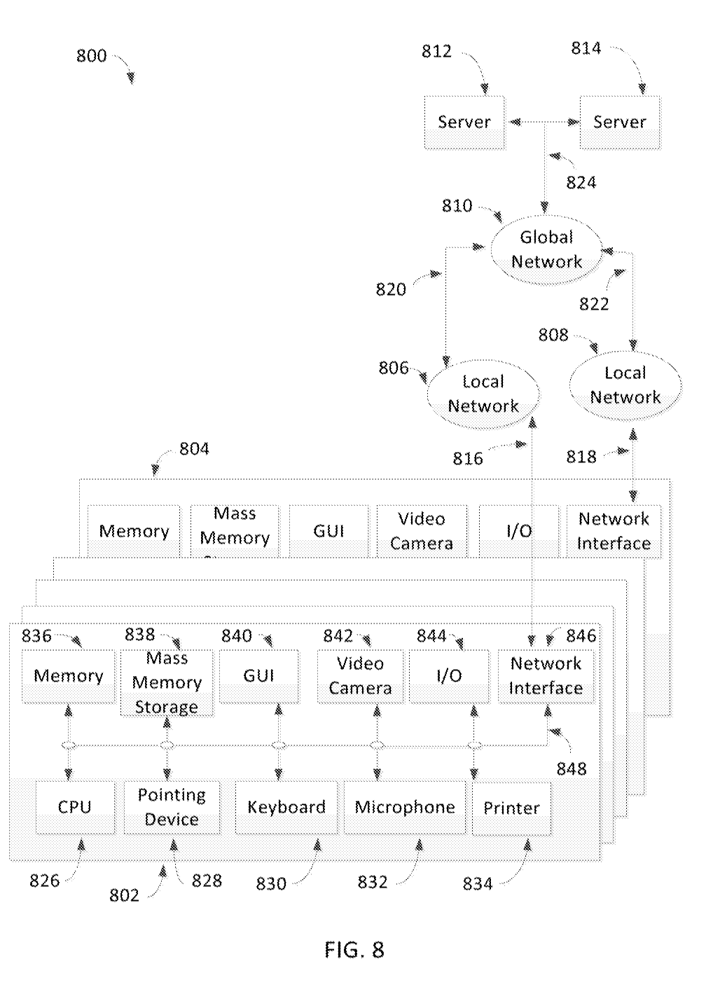

FIG. 8 is a block diagram depicting an exemplary client/server system which may be used by an exemplary web-enabled/networked embodiment of the present invention.

A communication system 800 includes a multiplicity of clients with a sampling of clients denoted as a client 802 and a client 804, a multiplicity of local networks with a sampling of networks denoted as a local network 806 and a local network 808, a global network 810 and a multiplicity of servers with a sampling of servers denoted as a server 812 and a server 814.

Client 802 may communicate bi-directionally with local network 806 via a communication channel 816. Client 804 may communicate bi-directionally with local network 808 via a communication channel 818. Local network 806 may communicate bi-directionally with global network 810 via a communication channel 820. Local network 808 may communicate bi-directionally with global network 810 via a communication channel 822. Global network 810 may communicate bi-directionally with server 812 and server 814 via a communication channel 824. Server 812 and server 814 may communicate bi-directionally with each other via communication channel 824. Furthermore, clients 802, 804, local networks 806, 808, global network 810 and servers 812, 814 may each communicate bi-directionally with each other.

In one embodiment, global network 810 may operate as the Internet. It will be understood by those skilled in the art that communication system 800 may take many different forms. Non-limiting examples of forms for communication system 800 include local area networks (LANs), wide area networks (WANs), wired telephone networks, wireless networks, or any other network supporting data communication between respective entities.

Clients 802 and 804 may take many different forms. Non-limiting examples of clients 802 and 804 include personal computers, personal digital assistants (PDAs), cellular phones and smartphones.

Client 802 includes a CPU 826, a pointing device 828, a keyboard 830, a microphone 832, a printer 834, a memory 836, a mass memory storage 838, a GUI 840, a video camera 842, an input/output interface 844 and a network interface 846.

CPU 826, pointing device 828, keyboard 830, microphone 832, printer 834, memory 836, mass memory storage 838, GUI 840, video camera 842, input/output interface 844 and network interface 846 may communicate in a unidirectional manner or a bi-directional manner with each other via a communication channel 848. Communication channel 848 may be configured as a single communication channel or a multiplicity of communication channels.

CPU 826 may be comprised of a single processor or multiple processors. CPU 826 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 836 is used typically to transfer data and instructions to CPU 826 in a bi-directional manner. Memory 836, as discussed previously, may include any suitable computer-readable media, intended for data storage, such as those described above excluding any wired or wireless transmissions unless specifically noted. Mass memory storage 838 may also be coupled bi-directionally to CPU 826 and provides additional data storage capacity and may include any of the computer-readable media described above. Mass memory storage 838 may be used to store programs, data and the like and is typically a secondary storage medium such as a hard disk. It will be appreciated that the information retained within mass memory storage 838, may, in appropriate cases, be incorporated in standard fashion as part of memory 836 as virtual memory.

CPU 826 may be coupled to GUI 840. GUI 840 enables a user to view the operation of computer operating system and software. CPU 826 may be coupled to pointing device 828. Non-limiting examples of pointing device 828 include computer mouse, trackball and touchpad. Pointing device 828 enables a user with the capability to maneuver a computer cursor about the viewing area of GUI 840 and select areas or features in the viewing area of GUI 840. CPU 826 may be coupled to keyboard 830. Keyboard 830 enables a user with the capability to input alphanumeric textual information to CPU 826. CPU 826 may be coupled to microphone 832. Microphone 832 enables audio produced by a user to be recorded, processed and communicated by CPU 826. CPU 826 may be connected to printer 834. Printer 834 enables a user with the capability to print information to a sheet of paper. CPU 826 may be connected to video camera 842. Video camera 842 enables video produced or captured by user to be recorded, processed and communicated by CPU 826.

CPU 826 may also be coupled to input/output interface 844 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 826 optionally may be coupled to network interface 846 which enables communication with an external device such as a database or a computer or telecommunications or internet network using an external connection shown generally as communication channel 816, which may be implemented as a hardwired or wireless communications link using suitable conventional technologies. With such a connection, CPU 826 might receive information from the network, or might output information to a network in the course of performing the method steps described in the teachings of the present invention.

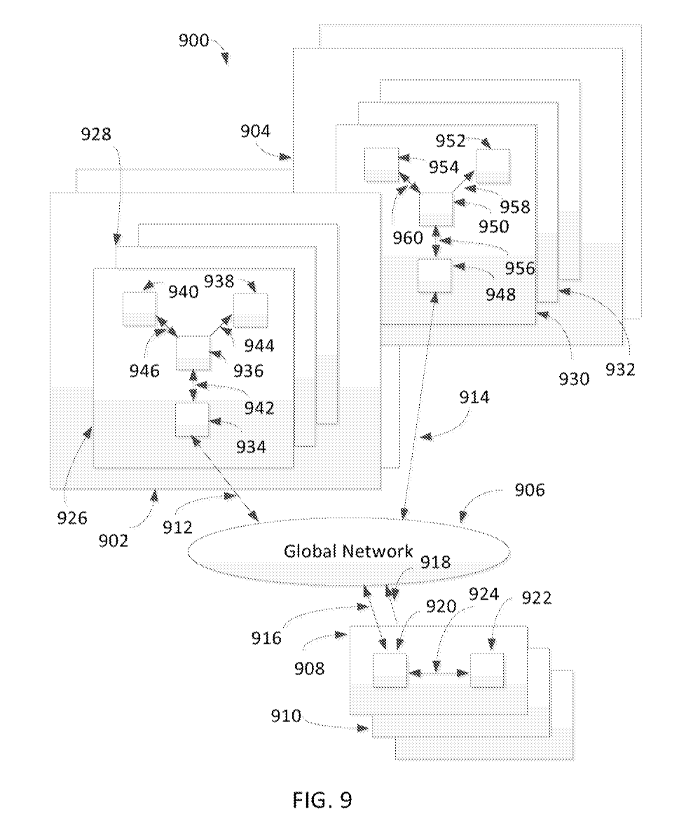

FIG. 9 illustrates a block diagram depicting a conventional client/server communication system.

A communication system 900 includes a multiplicity of networked regions with a sampling of regions denoted as a network region 902 and a network region 904, a global network 906 and a multiplicity of servers with a sampling of servers denoted as a server device 908 and a server device 910.

Network region 902 and network region 904 may operate to represent a network contained within a geographical area or region. Non-limiting examples of representations for the geographical areas for the networked regions may include postal zip codes, telephone area codes, states, counties, cities and countries. Elements within network region 902 and 904 may operate to communicate with external elements within other networked regions or within elements contained within the same network region.

In some implementations, global network 906 may operate as the Internet. It will be understood by those skilled in the art that communication system 900 may take many different forms. Non-limiting examples of forms for communication system 900 include local area networks (LANs), wide area networks (WANs), wired telephone networks, cellular telephone networks or any other network supporting data communication between respective entities via hardwired or wireless communication networks. Global network 906 may operate to transfer information between the various networked elements.

Server device 908 and server device 910 may operate to execute software instructions, store information, support database operations and communicate with other networked elements. Non-limiting examples of software and scripting languages which may be executed on server device 908 and server device 910 include C, C++, C# and Java.

Network region 902 may operate to communicate bi-directionally with global network 906 via a communication channel 912. Network region 904 may operate to communicate bi-directionally with global network 906 via a communication channel 914. Server device 908 may operate to communicate bi-directionally with global network 906 via a communication channel 916. Server device 910 may operate to communicate bi-directionally with global network 906 via a communication channel 918. Network region 902 and 904, global network 906 and server devices 908 and 910 may operate to communicate with each other and with every other networked device located within communication system 900.

Server device 908 includes a networking device 920 and a server 922. Networking device 920 may operate to communicate bi-directionally with global network 906 via communication channel 916 and with server 922 via a communication channel 924. Server 922 may operate to execute software instructions and store information.

Network region 902 includes a multiplicity of clients with a sampling denoted as a client 926 and a client 928. Client 926 includes a networking device 934, a processor 936, a GUI 938 and an interface device 940. Non-limiting examples of devices for GUI 938 include monitors, televisions, cellular telephones, smartphones and PDAs (Personal Digital Assistants). Non-limiting examples of interface device 940 include pointing device, mouse, trackball, scanner and printer. Networking device 934 may communicate bi-directionally with global network 906 via communication channel 912 and with processor 936 via a communication channel 942. GUI 938 may receive information from processor 936 via a communication channel 944 for presentation to a user for viewing. Interface device 940 may operate to send control information to processor 936 and to receive information from processor 936 via a communication channel 946. Network region 904 includes a multiplicity of clients with a sampling denoted as a client 930 and a client 932. Client 930 includes a networking device 948, a processor 950, a GUI 952 and an interface device 954. Non-limiting examples of devices for GUI 938 include monitors, televisions, cellular telephones, smartphones and PDAs (Personal Digital Assistants). Non-limiting examples of interface device 940 include pointing devices, mousse, trackballs, scanners and printers. Networking device 948 may communicate bi-directionally with global network 906 via communication channel 914 and with processor 950 via a communication channel 956. GUI 952 may receive information from processor 950 via a communication channel 958 for presentation to a user for viewing. Interface device 954 may operate to send control information to processor 950 and to receive information from processor 950 via a communication channel 960.

For example, consider the case where a user interfacing with client 926 may want to execute a networked application. A user may enter the IP (Internet Protocol) address for the networked application using interface device 940. The IP address information may be communicated to processor 936 via communication channel 946. Processor 936 may then communicate the IP address information to networking device 934 via communication channel 942. Networking device 934 may then communicate the IP address information to global network 906 via communication channel 912. Global network 906 may then communicate the IP address information to networking device 920 of server device 908 via communication channel 916. Networking device 920 may then communicate the IP address information to server 922 via communication channel 924. Server 922 may receive the IP address information and after processing the IP address information may communicate return information to networking device 920 via communication channel 924. Networking device 920 may communicate the return information to global network 906 via communication channel 916. Global network 906 may communicate the return information to networking device 934 via communication channel 912. Networking device 934 may communicate the return information to processor 936 via communication channel 942. Processor 946 may communicate the return information to GUI 938 via communication channel 944. User may then view the return information on GUI 938.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: social media portals, 3rd party aggregator service or any other component that may be decoupled as in a SAS (software as a service) environment.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breathe life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing computer software according to the present invention will be apparent to those skilled in the art. Various aspects of the invention have been described above by way of illustration, and the specific embodiments disclosed are not intended to limit the invention to the particular forms disclosed. The particular implementation of the computer software may vary depending upon the particular context or application. By way of example, and not limitation, the computer software described in the foregoing were principally directed to POS terminal implementations; however, similar techniques may instead be applied to any device suitable for receiving user information, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
transmitting at least an identifying information for an item to a server system, said item being chosen by a customer for purchase, said server system being configured for communicating with at least a social media platform to communicate at least a part of said identifying information wherein said social media platform returns to said server system at least one social media content related to said item;
receiving from said server system at least said one social media content; and
applying a filtering process to said received at least one social media content, said filtering process determining a disposition of said received at least one social media content for displaying to the customer.

2. The method as recited in claim 1, further comprising the step of displaying said received at least one social media content on a display device.

3. The method as recited in claim 1, further comprising the step of printing said received at least one social media content on a receipt for the customer.

4. The method as recited in claim 1, further comprising the step of transmitting to said server system a customer information for at least identifying the customer.

5. The method as recited in claim 4, in which said received at least one social media content further relates to said customer information.

6. The method as recited in claim 4, in which said customer information is obtained from a scanning of an instrument in possession of the customer.

7. The method as recited in claim 1, in which said server system is further configured for communicating said identifying information to one or more data providers wherein said one or more data providers returns to said server system at least one content related to said item.

8. The method as recited in claim 7, in which said one or more data providers returns content related to an item identified as a drug.

9. The method as recited in claim 1, further comprising the step of initiating a blocking of a purchase of said item based on said at least one social media content.

10. A system comprising:
a first computing system being configured to be operable for identifying an item chosen by a customer for purchase, said first computing system at least comprising an identifying module for identifying said item, a transmission module for communicating over a network, and a display module for displaying a transaction with the customer;
a server system being configured for communicating with said first computing system and for communicating with a social media platform, said server system receiving identifying information for the item from said first computing system, said server system communicating at least a part of said identifying information to said social media platform wherein said social media platform returns to said server system at least one social media content related to said item, said server system communicating said at least one social media content to said first computing system; and
a processing system being configured for applying a filtering process to said received at least one social media content, said filtering process determining a disposition of said received at least one social media content for displaying to the customer.

11. The system as recited in claim 10, further comprising a mobile computing device being in possession of the customer, said mobile computing device being configured to be operable for enabling the customer to view sales data, update social media and provide feedback during a purchase of said item, said first computing system further comprising a print module for generating a receipt for said purchase, said receipt comprising purchase details and said at least one social media content, said first computing system further comprising a code generation module for generating a code related to said item, said code being recognizable by said mobile computing device, said first computing system being operable for transmitting to said server system a customer information for at least identifying the customer wherein said customer information is obtained from a scanning of an instrument in possession of the customer and said at least one social media content further relates to said customer information, said server system being further configured for communicating said identifying information to one or more data providers wherein said one or more data providers returns to said server system at least one content related to said item, said server system communicating said at least one content to said first computing system for viewing by the customer, said server system further comprising a database storage system for storing a profile of the identified customer, a transaction history for the customer, returned social media content for the customer and demographic information for the customer.

12. A non-transitory computer-readable storage medium with an executable program stored thereon, wherein the program instructs one or more processors to perform the following steps:
transmitting at least an identifying information for an item to a server system, said item being chosen by a customer for purchase, said server system being configured for communicating with at least a social media platform to communicate at least a part of said identifying information wherein said social media platform returns to said server system at least one social media content related to said item;
receiving from said server system at least said one social media content; and
applying a filtering process to said received at least one social media content, said filtering process determining a disposition of said received at least one social media content for displaying to the customer.

13. The program instructing the processor as recited in claim 12, further comprising the step of displaying said received at least one social media content on a display device.

14. The program instructing the processor as recited in claim 12, further comprising the step of printing said at least one social media content on a receipt for the customer.

15. The program instructing the processor as recited in claim 12, further comprising the step of transmitting to said server system a customer information for at least identifying the customer.

16. The program instructing the processor as recited in claim 15, in which said at least one social media content further relates to said customer information.

17. The program instructing the processor as recited in claim 15, in which said customer information is obtained from a scanning of an instrument in possession of the customer.

18. The program instructing the processor as recited in claim 12, in which said server system is further configured for communicating said identifying information to one or more data providers wherein said one or more data providers returns to said server system at least one content related to said item.

19. The program instructing the processor as recited in claim 18, in which said one or more data providers returns content related to an item identified as a drug.

20. The program instructing the processor as recited in claim 12, further comprising the step of initiating a blocking of a purchase of said item based on said at least one social media content.
